(19) United States
(12) Patent Application Publication
(10) Pub. No.: US 2008/0233296 A1
(43) Pub. Date: Sep. 25, 2008

(54) Method Of Applying A Relatively Thick Protective Coating To A Sheet Metal Substrate

(76) Inventor: Gopal Subray Revankar, Moline, IL (US)

Correspondence Address: DEERE & COMPANY, ONE JOHN DEERE PLACE, MOLINE, IL, 61265, US

(21) Appl. No.: 11/688,964

(22) Filed: Mar. 21, 2007

(51) Int. Cl. B05D 3/02

(52) U.S. Cl. 427/383.1

(57) ABSTRACT

A sheet metal substrate is provided with a raised border which surrounds an area to be coated with a hardfacing. A slurry comprising a highly alloyed powder and a PVA binder is placed in the cavity defined by the border and the plate. The border has a height which exceeds the desired thickness of the finished coating, which is in excess of 2.0 mm by an amount equal to the shrinkage expected during curing and fusing steps.

### FIELD OF THE INVENTION

The present invention relates to parts having a wear resistant coating applied to them and more particularly relates to a method of applying a wear resistant coating to a sheet metal part, such as a forage harvester blower liner.

### BACKGROUND OF THE INVENTION

Many parts are subject to severe service conditions which result in the part becoming unduly worn if steps are not taken to increase their wear life. An example of such a part is the blower liner of a forage harvester, for example. Forage harvester blower liners are:
exposed to severe abrasive wear conditions due to high speed flow of forage and accompanying soil, sand and/or gravel which becomes mixed into the crop during the harvesting process;
exposed to corrosive conditions due to the presence of moisture and fertilizer residue in the forage; and
exposed to severe impacts of rocks, tramp metal and/or other hard objects that may become entrained in the forage.

The exposure to these three conditions call for a liner that has high hardness and one that is friction wear, corrosion and impact resistant. Also, the liner is required to have a smooth working surface to allow low friction flow of forage so that the forage harvester operates in an efficient manner. Finding a liner material that meets all of these criteria is very difficult. The next best solution is to find a coating for the liner surface which meets these criteria.

Examples of coating applied to blower liners using hardfacing methodology are well known. Even though hardfacing has been successful in increasing wear life, the materials are costly, the processes for applying hardfacing are labor intensive and too slow for production applications, and the resulting liner surface is rough and undulating, which is not ideal for efficient forage flow. Also, the known processes of applying hardfacing make it difficult to control the uniformity of the coating thickness.

Thermal sprayed coatings have been found to fail prematurely in service due to spalling and/or have been found to be too expensive to produce due to high material and/or processing costs. Further, it has been found that thermal sprayed coatings could not be applied thick enough (>2.0 mm) to extend the surface wear life since an increase in thickness also increased cohesive and adhesive stresses causing failure. Sprayed coatings can be applied to gradually build up the thickness, but this requires the substrate to be re-heated with each coating application to gradually build up the green coating thickness, with such re-heating and spraying steps adding to the cost and time of producing the coated part.

An example of a coating which has the attributes desired for use in a blower liner application is a slurry coating of highly alloyed powder like that disclosed in U.S. Pat. No. 5,879,743. Specifically, a slurry made in accordance with this patent is prepared by thoroughly mixing a powdered, hardfacing alloy with a PVA binder solution to give the desired alloy-to-binder solution weight ratio. The slurry compositions described in the patent are designed by an eight-digit code. For example, for a “0550/07550” slurry, the first four digits indicate a 5.5 to 1 weight ratio of powdered alloy to PVA solution, and the last four digits indicate a 7.5% (by weight) aqueous solution of PVA as a binder. In this designation, the decimal point is assumed to occur in the middle of each four digit group. Likewise, “1075/1025” means a ratio of alloy to PVA of 10.75 to 1, and the aqueous solution of PVA is 10.25% PVA, by weight, in water.

Thus, the problem to be solved is that of providing an economical process for applying a protective coating to a sheet metal substrate, such as a forage harvester blower liner, which has the characteristics of good friction wear, corrosion and impact resistance while producing a very smooth surface.

### SUMMARY OF THE INVENTION

According to the present invention, there is provided an improved process for applying a protective coating, having the aforementioned desired characteristics, to a sheet metal substrate.

An object of the invention is to apply a relatively thick (>2 mm) slurry coating to a sheet metal forage blower housing liner such that the coating is applied in a single step after first preparing the liner for receiving the coating and to thereafter cure the coating.

### BRIEF DESCRIPTION OF THE DRAWINGS

FIG. 1 is a somewhat schematic, left side elevational view of a self-propelled forage harvester embodying a blower of the type with which the present invention is particularly adapted for use.

FIG. 2 is a schematic, vertical sectional view of the blower shown in FIG. 1, and revealing the coated blower liner.

FIG. 3 is a view showing a curved steel plate being prepared for forming a coated blower liner, as shown in FIG. 2, by having magnetic tape applied thereto to form a raised border so as to form a cavity for receiving a slurry of hardfacing material.

FIG. 4 is a view showing the curved steel plate of FIG. 3 at a step in the process of making a coated blower liner wherein the magnetic tape has been removed after the plate coated with slurry has been heated to a sufficient temperature for a sufficient period of time to cause the slurry to become partially cured.

FIG. 5 is a view showing a curved steel plate, like that shown in FIG. 3, inserted into a fixture which, together with the plate, defines a cavity for receiving a slurry of hardfacing material.

### DESCRIPTION OF THE PREFERRED EMBODIMENT

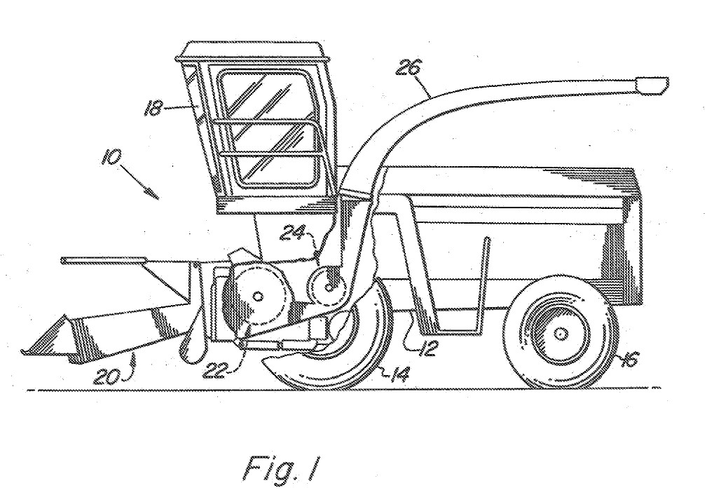

Referring now to FIG. 1, there is shown a self-propelled forage harvester 10 which embodies the present invention, it being noted that the principles of the present invention could be applied to any piece of machinery having steel plate surfaces subject to impact, corrosion and/or wear conditions where hardfacing of the surfaces would be beneficial for extending the wear life of the part subject to one or more of these conditions.

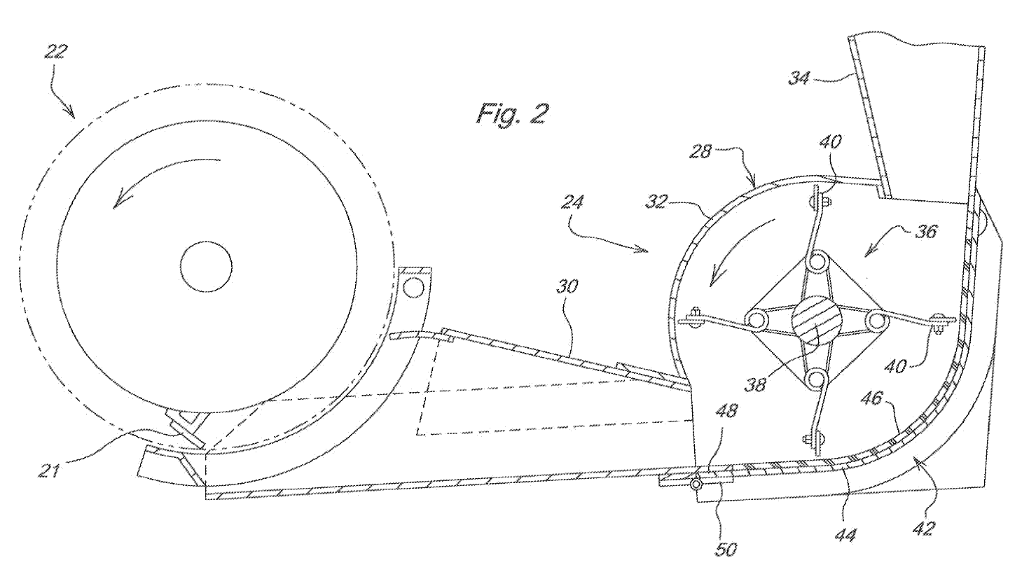

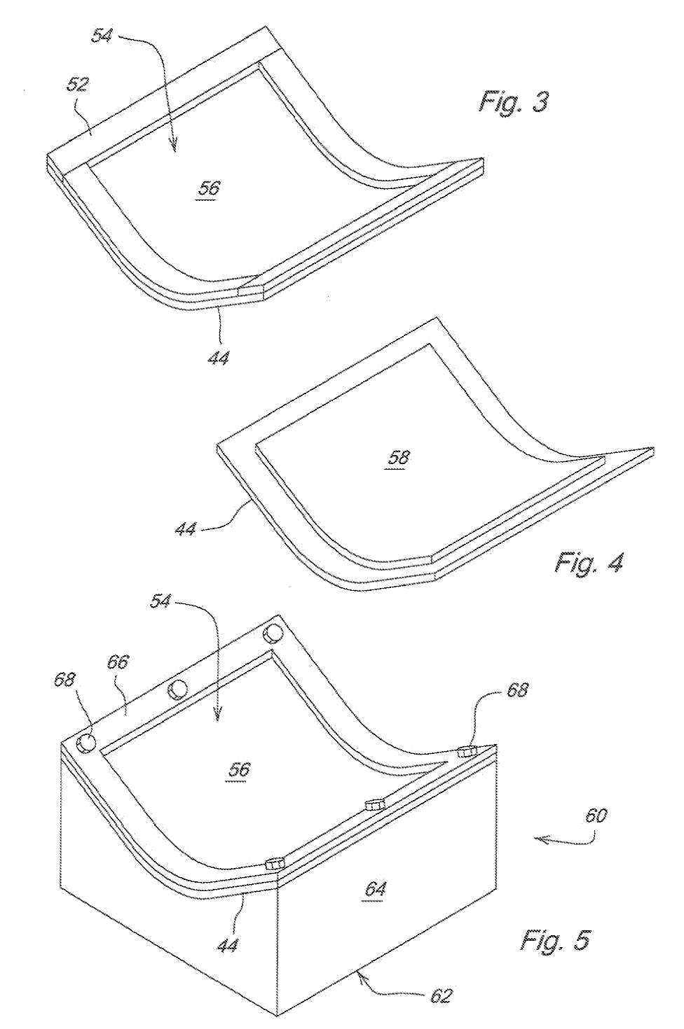

The forage harvester 10 includes a main frame 12 supported on front and rear pairs of wheels 14 and 16, of which only one of each pair is shown. Located at an upper forward location on the frame 12 is an operator's cab 18, which contains all of the controls (not shown) for the harvester. Mounted to the forward end of the frame 12 is a row crop harvesting head 20 which is provided for severing crop, such as corn, or the like, from the ground and directing it to be chopped into forage by knives 21 (FIG. 2—only one shown for the sake of simplicity) of a transverse cylinder cutterhead 22. Chopped forage is delivered rearwardly by the cutterhead 22 to an impeller or blower assembly 24, which, in turn, delivers the chopped forage upwardly into a discharge chute or spout 26 which directs the forage to a container (not shown) of a transport vehicle.

Referring now also to FIG. 2, it can be seen that the blower assembly 24 includes a generally cylindrical housing 28, with the cutterhead 22 being coupled to an inlet provided at a lower front location of the housing 28 by a crop transfer housing 30, and with an outlet provided at an upper rear location of the housing 28 being coupled to the chute or spout 26 by an outlet conduit 34. A blower impeller 36 includes a drive shaft 36 located along a horizontal, transverse axis at the center of the housing 28 and coupled to the shaft 38 are a plurality of pivotally mounted paddles 40.

It is noted that chopped crop exits the cutterhead 22 along a path extending tangentially from the bottom of the cutterhead 22 and tangentially into a lower location of the blower housing 28. Upon being driven counterclockwise, the blower impeller 36 engages crop entering the housing 28 and carries it through an angle of approximately 90° where it expels the crop into the outlet conduit 34.

The blower housing 28 includes a circumferential wall section 42, which extends between opposite side walls of the housing 28, and from the inlet to the outlet of the housing 28. The location of the wall section 42 of the housing 28 results in it being subject to high impact loading due to any hard particles such as sand, rocks and/or tramp metal that may be entrained in the stream of crop ejected from the cutterhead 22. The wall section 42 includes a curved steel plate 44 having a central surface area to which is bonded a hardfacing material 46. An uncoated border 48 surrounds this central area and overlaps a bottom side of the transfer housing 30 and a rear side of the outlet conduit 34. A bottom section of the border 48 is fixed to a hinge 50, while a top section of the border is secured to the outlet conduit by appropriate fasteners (not shown). Thus, by removing these fasteners, the housing wall section 42 may be pivoted to an open position permitting access to the blower impeller 36 for service, or for the purpose of cleaning out clogged material, for example.

Referring now to FIG. 3, there is shown a step in the manufacture of the blower housing wall section 42 following a step wherein a flat sheet of steel plate has been formed to define the steel plate 44. A magnetic tape 52 has been applied about a peripheral region of the plate 50 so as to form a cavity 54 having a bottom defined by a surface area 56 on which it is desired to apply a wear and corrosive resistant coating or so-called hardfacing. The cavity 54 is provided for receiving a slurry of the highly alloyed powder constituents for making the finished coating, with the height of the magnetic tape 52 from the surface area 56 being equal to the desired thickness of the finished coating plus the amount of shrinkage expected during the curing and fusing of the slurry. It has been found that the particular slurry used yields a fused coating thickness which is approximately half the green coating thickness. Since a finished coating thickness of at least 2.0 mm is desired, the height of the tape 52 is at least 4 mm.

Once the slurry is placed in the cavity 54, a striking device, having a straight edge which spans the width of the plate 44, is used to strike off the slurry so as to remove excess slurry and so as to produce a uniform slurry thickness corresponding to the height of the magnetic tape 52. The striking operation should be done carefully not to produce any cracks in the green coating. Specifically, during the striking step, striker oscillations should be kept small and the progression of the striker should be slow, otherwise cracks may result. In order to avoid cracking in the coating after fusion, the striking process should be completed a soon as possible after the slurry is poured on the plate and while the slurry is till wet, i.e., before onset of the curing process of the binder.

A robot or other automated device could be used to perform the striking operation. The straight edge could be constructed as part of a component which is spring mounted so that the straight edge may be oriented parallel to one end of the metal plate 56 and brought into contact with the magnetic tape 52. The robot would be operated to move the component embodying the straight edge about a radius of curvature which approximates the curvature of the plate 56, with the spring mounting of the component maintaining the straight edge in tight engagement with the magnetic tape running along the sides of the plate 56. In addition, the robot could be programmed to undergo a slight oscillation as it progresses along the plate 56.

Once the slurry is in place, the slurry coated plate 44, together with the magnetic tape 52 is placed in a curing oven at a temperature of about 200° F. for 10-15 minutes.

The plate 44 is then removed from the oven and the magnetic tape is removed from the plate 44 leaving a partially cured coating 58. The plate 44, together with the coating 56 are then placed in the oven and heated at 200° F. for at least one hour.

To fuse the coating 58 to the plate 44, the plate 44 and coating 58 are placed in an oven in a hydrogen atmosphere and heated to a temperature of 2000-2025° F. The coating 58 then becomes the layer of hardfacing 46, as shown in FIG. 2.

Referring now to FIG. 5, there is shown an alternate manner of forming the cavity 54. Specifically, a fixture assembly 60 is shown including a support structure 62, here shown as having a box shape. The support structure 62 is representative of any framework which may be provided for supporting the plate 44, and while the support structure 62 may be formed from a solid block of material, it preferably is formed with four walls, with at least end walls 64 having a thickness commensurate with that of a border member 66 secured in place by a plurality of threaded fasteners 68 extending through aligned holes provided in the border member 66, plate 44 and walls 64, with the holes in the walls 64 being threaded. To avoid any complications in the striking step which might result from the presence of the fasteners 68 shown, the fasteners could be replaced with a type having countersunk heads, for example. Like the previously described magnetic tape 52, the thickness of the border member 66 would be chosen so as to be equal to the desired thickness of the finished coating of hardfacing plus the expected shrinkage of the green coating surface during the curing and fusing.

Instead of the fixture assembly 60, other fixture assemblies could be used such as one which employees releasable clamps for fixing the border member 66 to the plate 44, for example.

Having described the preferred embodiment, it will become apparent that various modifications can be made without departing from the scope of the invention as defined in the accompanying claims.

1. A method for hardfacing a desired zone of a surface of a steel plate substrate such that a coating of wear resistant material having a thickness of at least 2 mm is formed on said zone of said steel plate substrate, comprising the steps of:
a. selecting a steel plate having a desired shape and size;
b. creating a barrier on a surface of said plate that extends about said desired zone, with the barrier having a height of at least 4 mm so as to cooperate with said desired zone to define a cavity;
c. preparing a substantially uniformly thick, aqueous slurry, without flux, consisting essentially of polyvinyl alcohol, a fusible hard metal alloy with at least 60% iron in the form of a finely divided powder, and, one or more non-flux additives selected from the group consisting of dispersants, deflocculants and plasticizers;
d. wetting said zone of said steel plate with a polyvinyl alcohol binder solution;
e. filling said cavity with said aqueous slurry;
f. striking said slurry in said cavity so as to leave a smooth surface and so as to produce a thickness of said slurry substantially equal to said height of said barrier;
g. warming said plate to a curing temperature for a time sufficient to partially cure said slurry;
h. removing said barrier;
i. warming said plate to said curing temperature for a time sufficient to fully cure said slurry;
j. heating said plate coated with the fully cured slurry to a fusing temperature of said hard metal alloy in a protective atmosphere until the alloy has fused onto the metal surface; and
k. cooling said plate with the fused coating to ambient temperature.

2. The material of hardfacing, as defined in claim 1, wherein said curing temperature is about 200° F.

3. The method of hardfacing as defined in claim 1, wherein said fusing temperature is from 2000-2025° F.

4. The method of hardfacing, as defined in claim 1, wherein said step of creating a barrier is done by placing said steel plate in a fixture assembly which forms said barrier.

5. The method of hardfacing, as defined in claim 1, wherein said step of creating a barrier is done by applying a magnetic strip about said zone.

6. The method of hardfacing, as defined in claim 1, and further including the step of spraying a thin slurry mixture onto said thick aqueous slurry soon after the step of striking said slurry, thereby creating a more smooth slurry surface.

7. The method of hardfacing, as defined in claim 1, wherein said step of striking said slurry is performed by keeping striker oscillations small and by moving said strike slowly.

8. The method of hardfacing, as defined in claim 7, wherein said striking process is completed prior to any onset of curing by action of the binder.
